(19) United States
(12) Patent Application Publication
(10) Pub. No.: US 2012/0066641 A1
(43) Pub. Date: Mar. 15, 2012

(54) METHODS AND APPARATUS FOR EXPANDABLE WINDOW BORDER

(76) Inventor: Dermot P. Doherty, San Miguel de Allenda (MX)

(21) Appl. No.: 12/881,640

(22) Filed: Sep. 14, 2010

(51) Int. Cl. G06F 3/048

(52) U.S. Cl. 715/800

(57) ABSTRACT

In some embodiments, a non-transitory processor-readable medium storing code representing instructions to cause a processor to perform a process includes code to send a signal to an electronic device to define a window viewable on a display of the electronic device. The window has an application portion and a border portion having a first width. The signal can cause at the electronic device an event listener component to be associated with at least a portion of the border portion of the window. The event listener component can detect a mouseover event on the portion of the border portion of the window. The signal can also cause at the electronic device the border portion of the window to be expanded to a second width greater than the first width when a mouseover event is detected by the event listener component.

### BACKGROUND

Some embodiments described herein relate generally to electronic devices that can communicate within a communication network using a web browser, and more particularly, to electronic devices, servers and systems having enhanced window interface functionality.

Known operating systems can provide basic window interface functions that include rendering a window on an electronic device, such as a personal computer. A window typically includes an application portion and a border portion that surrounds or frames the application portion. The border portion can be used to select and drag or move the window within the display of the electronic device. The border portion typically has a relatively small width (e.g., 3 pixels), which can be difficult in some situations for a user to hover the curser over to, for example, select, resize and/or move the window.

Thus, it would be desirable to provide a window interface system that can provide enhanced windowing functions, such as the ability to expand a border of a window to increase the border grabbing area for the user, while eliminating or reducing the undesirable movement or jumpiness of the window during the expansion process.

### SUMMARY

In some embodiments, a non-transitory processor-readable medium storing code representing instructions to cause a processor to perform a process includes code to send a signal to an electronic device to define a window viewable on a display of the electronic device. The window has an application portion and a border portion having a first width. The signal can cause at the electronic device an event listener component to be associated with at least a portion of the border portion of the window. The event listener component can detect a mouseover event on the portion of the border portion of the window. The signal can also cause at the electronic device the border portion of the window to be expanded to a second width greater than the first width when a mouseover event is detected by the event listener component.

### BRIEF DESCRIPTION OF THE DRAWINGS

FIG. 1 is a schematic block diagram of a computer network system in which enhanced windowing functions can be embodied, according to an embodiment.

FIG. 2 is a schematic illustration of an electronic device, according to an embodiment.

FIG. 3 is a schematic illustration of a window system server, according to an embodiment.

FIG. 4 is a front view of a window, according to an embodiment.

FIG. 5 is an enlarged front view of a portion of the window of FIG. 4.

FIG. 6 is a schematic illustration of the window of FIG. 4.

FIG. 7 is a front view of the window of FIG. 4 illustrating an expanded border of a window when a mouseover event has been detected, according to an embodiment.

FIG. 8 is an enlarged front view of a portion of the window of FIG. 4 illustrating an expanded border portion of the window.

FIGS. 9a-9c are each a front view of the window of FIG. 4 defined within a display of an electronic device showing various stages of a border expansion method, according to an embodiment.

FIG. 10 is a schematic illustration of an electronic device, according to an embodiment.

FIG. 11 is flow chart illustrating a method of expanding a border portion of a window, according to an embodiment.

### DETAILED DESCRIPTION

Apparatus, systems and methods are described herein to provide enhanced windowing functions on a device, such as, for example, an electronic device. Enhanced windowing functions can be provided by a widow interface application that can be included or embodied, for example, on an electronic device (e.g., a personal computer) and/or can be provided or embodied at a server and accessible by one or more electronic devices via a web browser. The window interface application can include user interface features, such as, for example, the desktop, the toolbar, the dockbar, the spaces, and context menus. The window interface application as described herein can include a module to render a window viewable within a display of an electronic device and a module to associate an event listener component to at least a portion of the window. The event listener component can detect a mouseover event on, for example, a border or frame of the window. The window interface application can also include a module to expand the width of the border of the window upon detection that a mouseover event has occurred. For example, a border portion of a window can be expanded as the user mouses over (moves a curser over) the border portion producing a larger “grabbing” area for the user to move and align the window within the display of the electronic device. In some embodiments, the border portion can be expanded, for example, from a border width of 3 pixels to a border width of 8 pixels. In some embodiments, the window interface application can expand or enlarge a border portion of a window while the application portion of the window appears to stay in substantially the same location on the display.

The window interface application can be operated on a variety of different types of electronic devices and systems. In some embodiments, the window interface application is provided by a server to an electronic device. For example, in some embodiments, the window interface application is performed by software (executed on hardware), hardware, or a combination thereof at a server and an electronic device is provided access to the window interface application at the server. In some embodiments, the window interface application can be embodied at an electronic device, such as, a personal computer. For example, the window interface application can be performed by software (executed on hardware), hardware, or a combination thereof at such an electronic device.

In some embodiments, a non-transitory processor-readable medium storing code representing instructions to cause a processor to perform a process includes code to send a signal to an electronic device to define a window viewable on a display of the electronic device. The window has an application portion and a border portion having a first width. The signal can cause at the electronic device an event listener component to be associated with at least a portion of the border portion of the window. The event listener component can detect a mouseover event on the portion of the border portion of the window. The signal can also cause at the electronic device the border portion of the window to be expanded to a second width greater than the first width when a mouseover event is detected by the event listener component.

In some embodiments, a non-transitory processor-readable medium storing code representing instructions to cause a processor to perform a process includes code to define a window viewable on a display of a device. The window can have an application portion and a border portion having a first width. The non-transitory processor-readable medium further includes code to expand the border portion viewable on the display to a second width greater than the first width when a mouseover event is detected within the border portion.

In some embodiments, a method includes receiving a signal to define a window viewable on a display of an electronic device. The window can have an application portion and a border portion having a first width. An event listener component can be associated with at least a portion of the border portion. The event listener component can be configured to detect a mouseover event on the portion of the border portion. A signal can be sent to cause the border portion to expand to a second width greater than the first width when a mouseover event is detected by the event listener component.

As used herein the, terms “mouseover” and “mouses over” can mean, for example, an occurrence of or an act of, a user of an electronic device moves a curser within a display of the electronic device. The curser can be moved with, for example, a mouse, a joystick, a touch pad or touch screen, etc.

As used herein, the term “window object” can mean, for example, code (e.g., dynamic hyper text markup language (DHTML) object(s)) that is used to define a “window” within a display of an electronic device, such as a personal computer. As used herein, the term “window” can mean, for example, a portion of a display of an electronic device that can contain content different from the rest of the display. A window can include, for example, an application portion and a border portion that surrounds the application portion. A “window-based application” can mean, for example, an application capable of controlling context within a window, such as Microsoft Word, Adobe, etc., executable on an electronic device.

As used in this specification, the singular forms “a,” “an” and “the” include plural referents unless the context clearly dictates otherwise. Thus, for example, the term “a module” is intended to mean a single module or a combination of modules.

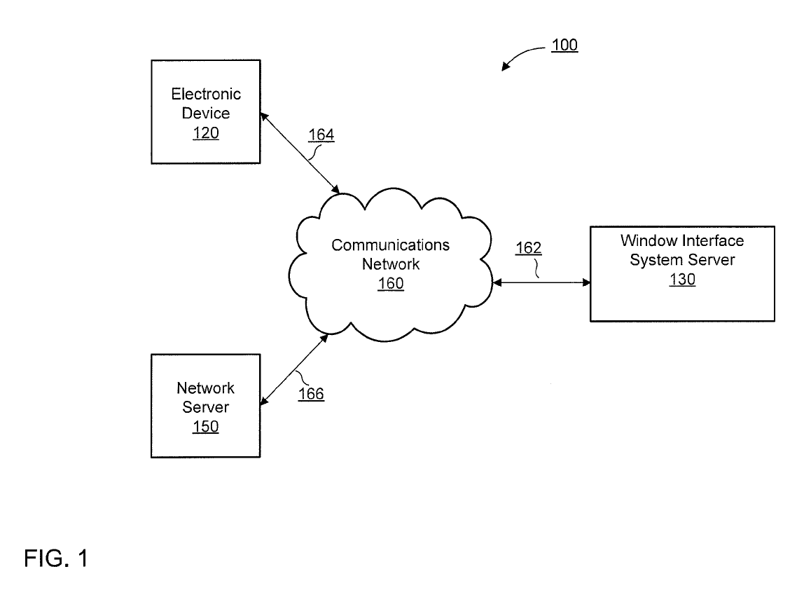

FIG. 1 is a schematic block diagram of computer network system that can include servers and computers having enhanced windowing features as described herein, according to an embodiment. A computer network system 100 can include one or more electronic devices 120, a window interface system server 130 (also referred to as “window system server” or “system server”), and a network server 150 each of which can be operatively coupled to each other via a communications network 160. Thus, FIG. 1 is merely an example illustrating the types of devices that can be included within a computer network system 100.

Communications network 160 can be any communications network, such as the Internet, configurable to allow the one or more electronic devices 120, the window system server 130 and the network server 150 to communicate with communications network 160 and/or to each other through communications network 160. Communications network 160 can be any network or combination of networks capable of transmitting information (e.g., data and/or signals) and can include, for example, a telephone network, an Ethernet network, a fiber-optic network, a wireless network, and/or a cellular network.

In some embodiments, communications network 160 can include multiple networks operatively coupled to one another by, for example, network bridges, routers, switches and/or gateways. For example, the electronic devices 120 can be operatively coupled to a cellular network and the window system server 130 can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communications network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communications network.

As illustrated in FIG. 1, window system server 130 is operatively coupled to communications network 160 via network connection 162; electronic device 120 is operatively coupled to communications network 160 via network connection 164; and the network server 150 is operatively coupled to communications network 160 via network connection 166. Network connections 162, 164 and 166 can be any appropriate network connection for operatively coupling window system server 130, electronic device 120, and network server 150, respectively, to communications network 160.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a wired connection such as, for example, an Ethernet connection, a digital subscription line (“DSL”) connection, a broadband coaxial connection, and/or a fiber-optic connection.

As mentioned above, in some embodiments, a computer network system 100 can include more than one electronic device 120, more than one window system server 130 and/or more than one network server 150. Thus, for example, an electronic device 120 can access multiple network servers and a network server can communicate with multiple electronic devices. In some embodiments, an electronic device 120, a network server 150 and/or a window system server 130 can be operatively coupled to the communications network 160 by heterogeneous network connections. For example, a first electronic device 120 can be operatively coupled to the communications network 160 by a WWAN network connection, another electronic device 120 can be operatively coupled to the communications network 160 by a DSL network connection, and a window system server 130 can be operatively coupled to the communications network 160 by a fiber-optic network connection.

The network server 150 can be, for example, a web server configured to provide electronic devices, such as electronic device 120, web access across the communications network 160. For example, the electronic device 120 can be in communication with the window system server 130 via the communications network 160 and the network server 150, and the network server 150 can facilitate communication between the electronic device 120 and other electronic devices and/or servers.

The electronic device 120 can be any of a variety of electronic devices that can be operatively coupled to communications network 160. An electronic device 120 can be a personal computer, a laptop computer, a personal digital assistant (PDA), a cellular telephone, a portable/mobile internet device and/or some other electronic communication device. Electronic device 120 can include a web browser configured to access a webpage or website hosted on or accessible via the network server 150 over communications network 160. The electronic device 120 can be configured to support, for example, HTML using JavaScript. For example, the electronic device 120 can include a web browser, such as, Firefox, Safari, Opera and Chrome. A webpage or website can be accessed by a user of a web browser at electronic device 120 by providing the web browser with a reference such as a uniform resource locator (URL), for example, of a webpage. For example, a user of an electronic device 120 can access the window system server 130 via a URL designated for the window system server 130. In some embodiments, electronic device 120 can include specialized software for accessing a web server other than a browser, such as, for example, a specialized network-enabled application or program. In some embodiments, portions of a website accessible via a web server can be located in a database (not shown) accessible to the web server.

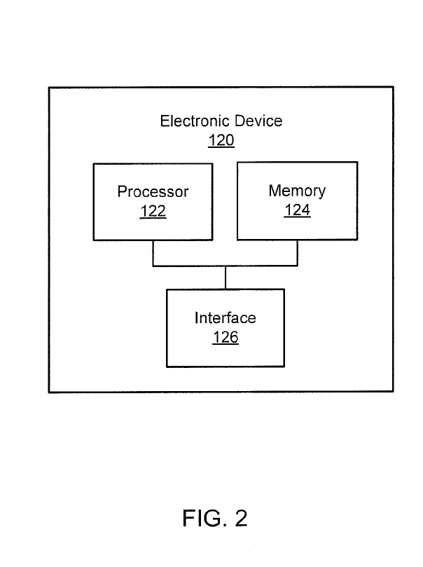

As shown in FIG. 2, an electronic device 120 can include a processor 122, an interface 124, and a memory 126 each of which can be configured as described in more detail below for window system server 130. The computing device 120 can also include (each not shown) a display or monitor, a keyboard, various ports (e.g., a USB port), and other user interface features, such as, for example, touch screen controls, audio components, and/or video components. The electronic device 120 can be operatively coupled to communications network 160 via the interface and network connection 124.

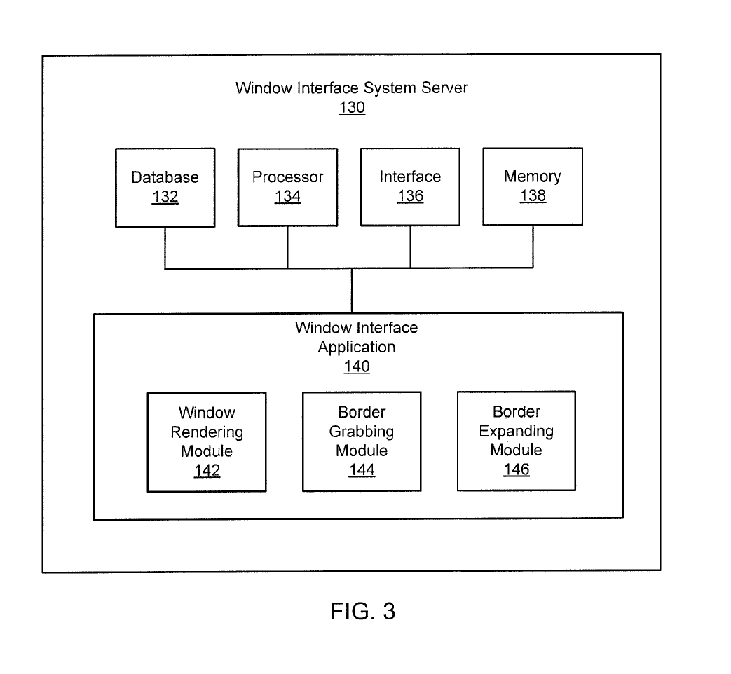

As illustrated in FIG. 3, the window system server 130 can include a database 132, a processor 134, an interface 136 and a memory 138. The window system server 130 can be operatively coupled to the communications network 160 via interface 136 and the network connection 162 as discussed above. Interface 138 can be any interface configurable to be operatively coupled to communications network 160 via network connection 162. An interface can be one or more wired and/or wireless data connections, such as connections conforming to one or more known information exchange standards, such as wired Ethernet, wireless 802.11x (“Wi-Fi”), high-speed packet access (“HSPA”), worldwide interoperability for microwave access (“WiMAX”), wireless local area network (“WLAN”), Ultra-wideband (“UWB”), Universal Serial Bus (“USB”), Bluetooth®, infrared, Code Division Multiple Access (“CDMA”), Time Division Multiple Access (“TDMA”), Global Systems for Mobile Communications (“GSM”), Long Term Evolution (“LTE”), broadband, fiber optics, telephony, and the like.

The processor 134 is operatively coupled to interface 136 such that processor 134 can be configured to be in communication with communications network 160 via interface 136. Processor 134 can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages such as, for example, Java™, C++, C, assembly, a hardware description language, or any other suitable programming language. A processor according to some embodiments includes media and computer code (also can be referred to as code) specially designed and constructed for the specific purpose or purposes. In some embodiments, the processor 134 can support standard HTML, and software languages such as, for example, JavaScript, JavaScript Object Notation (JSON), Asynchronous JavaScript (AJAX).

In some embodiments, a processor can be, for example, a single physical processor such as a general-purpose processor, an ASIC, a PLD, or a FPGA having a single processing core or a group of processing cores. In some embodiments, a processor can be a group or cluster of processors such as a group of physical processors operatively coupled to a shared clock or synchronization signal, a shared memory, a shared memory bus, and/or a shared data bus. In other words, a processor can be a group of processors in a multi-processor computing device. In some embodiments, a processor can be a group of distributed processors (e.g., computing devices with one or more physical processors) operatively coupled one to another via a communications network. Thus, a processor can be a group of distributed processors in communication one with another via a communications network. In some embodiments, a processor can be a combination of such processors. For example, a processor can be a group of distributed computing devices, where each computing device includes a group of physical processors sharing a memory bus and each physical processor includes a group of processing cores.

In some embodiments, a server (or processor) can be a virtual device implemented in software such as, for example, a virtual machine executing on or in a processor. For example, a server can be a software module executing in a virtual machine environment such as, for example, a Java™ module executing in a Java™ Virtual Machine (“JVM”), or an operating system executing in a VMware™ virtual machine. In some such embodiments, a network interface, a processor, and a memory can be virtualized and implemented in software executing in, or as part of, a virtual machine.

Processor 134 is also operatively coupled to memory 138. Memory 138 can be, for example, a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

In some embodiments, the database 132 can be directly coupled to window system server 130. For example, the database 132 can be coupled to, or incorporated within, the window system server 130. In some embodiments, the database can be operatively coupled to, and accessible by, the window system server 130 via a communications network. For example, the database 132 can be accessible by the window system server 130 via the communications network 160 or via a network separate from communications network 160, such as a local area network (“LAN”). The database 132 can include an interface, a processor and a memory (each not shown) as described above for window system server 130.

In some embodiments, the window interface system server 130 can be a data server included within a cloud computing server that can provide operating systems, software, computer storage resources, data processing resources, technical support services and/or other computing resources to multiple electronic devices 120. For example, computing capabilities, storage capabilities, products and services can be leased or sub-leased from the data server.

The window interface system server 130 can be accessed by one or more electronic devices 120 via a web browser, and provide the user of the electronic device 120 with a window interface application 140. The window interface application 140 can be included, for example, in the processor 132, the database 134, or the memory 138. A user of an electronic device 120 can, for example, connect to or log-on to the window system server 130 via a web browser, and the window interface application 140 can be downloaded to a memory on the electronic device 120 or made accessible for use on the electronic device 120. In such an instance, the window interface application 140 can include, or can be defined at least in part by, a JavaScript file (extension .JS) included and/or referenced in a web page downloaded by the web browser. The window interface application 140 can provide a user-interface web page, providing access to the window system server 130. The web page that is sent to the user (e.g., electronic device 120) can contain a <SCRIPT> tag that in turn requests additional system code from the window system server 130 to further define the window interface application 140. The window interface application 140 can then begin to download onto the electronic device 120. During the download, the window interface application 140 can be built at the electronic device 120 and can include interface features, such as, for example, the Desktop, the Toolbar, the Dockbar, the Spaces, and/or Context Menus. The window interface application 140 can then execute on the electronic device 120.

The window interface application 140 can include a window rendering module 142, a border grabbing module 144 and a border expanding module 146. The window rendering module 142 can be any valid combination of hardware and/or software (executing on hardware) to enclose or provide a frame around an application portion of a window such that the window can be dragged, maximized and resized. In some embodiments, the window interface application 140 may not include a window rendering module 142. In such an embodiment, the window rendering module functionality can be provided by a browser at the electronic device. When a user of an electronic device 120 selects or clicks on a window-based application icon in the Toolbar (provided by the window interface application 140), the window system server 130 can launch that particular window-based application (within a separate window) at the user's electronic device 120. In some embodiments, the window based application can be launched within a subsequent or separate browser window at electronic device 120. The window rendering module 142 executing on the electronic device 120 can produce the enclosing frame portion or border portion around the application portion of the window that allows the window (of the window-based application) to be dragged, maximized and resized. When the window interface application 140 is starting up, it can produce an object of the window component class, and adds the window-based application to the object. As the window-based application builds itself, it can create or define an HTML element. Once the window-based application has finished building, this HTML element can be appended to a Document Object Model (DOM), causing the window of the window-based application to be shown on the display screen of the electronic device 120. The initial web page is defined, at least in part, by the DOM can is provided from the window system server 130 that is running in the browser of the electronic device 120.

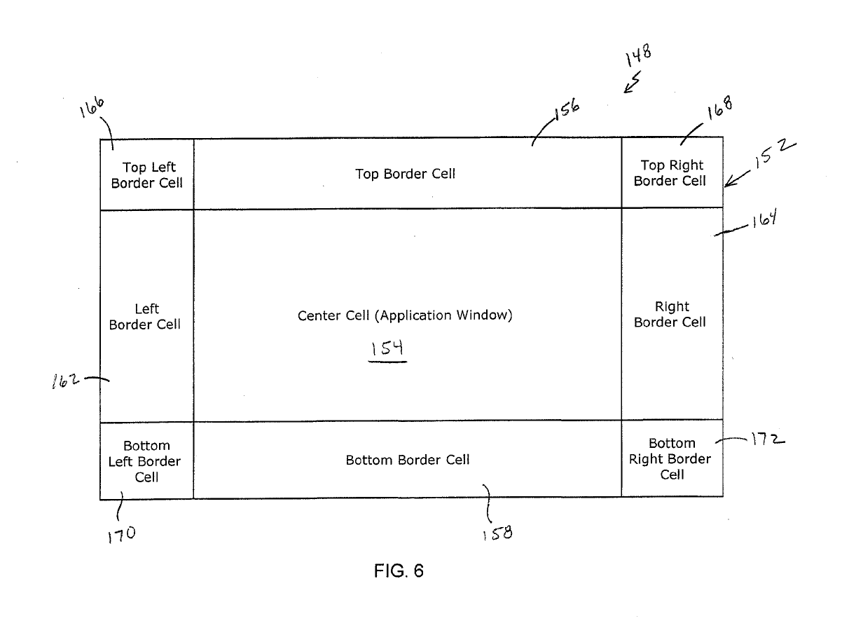

The border grabbing module 144 can be any valid combination of hardware and/or software (executing on hardware) to detect when a mouseover event occurs over a portion of a border portion of a window. For example, the border grabbing module 144 can be the hardware and/or the software (executing on hardware) activated when a portion of a JavaScript file is executed. As a window is defined for a window-based application, the window can be laid out in a grid with a center cell being defined as the application portion of the window and eight outer cells being defined as the border portion of the window (described in more detail with reference to FIG. 6). The border grabbing module 144 can associate an event listener component (also referred to as an “event handler component”) to each of the eight outer cells (associated with the border portion) of the window. The event listener component can detect when a mouseover event occurs within the border portion of the window. The ability to attach (e.g., define or associate) an event listener component to a HTML element is implemented by the DOM and the engine (e.g., a JavaScript engine) of the browser of the electronic device 120. The border grabbing module 144 can send a signal to the engine of the browser of the electronic device 120 to cause the engine to attach (define or associate) the event listener component to each of the eight outer cells.

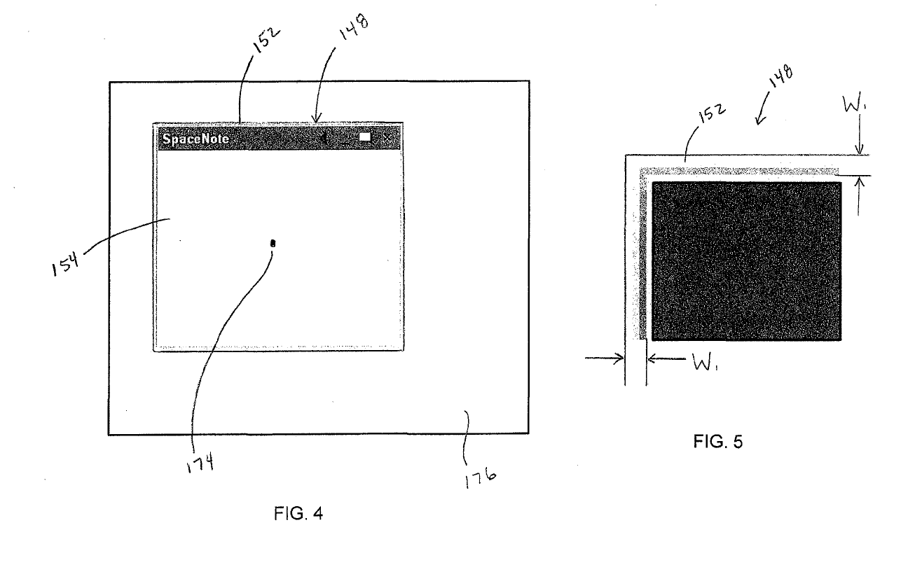

The border expanding module 146 can be any valid combination of hardware and/or software (executing on hardware) to expand the border portion of a window executing or displaying on an electronic device 120. For example, the border expanding module 146 can be the hardware and/or the software (executing on hardware) activated when a portion of a JavaScript file is executed. For example, a border portion of a window can be expanded as the user mouses over a portion of the border portion of the window, producing a larger “grabbing” area for the user to move, resize, and/or maximize the window within the display of the electronic device 120. When the border grabbing module 144 (described above) detects a mouseover event on one of the eight outer cells associated with the border portion of the window, the border grabbing module 144 sends a signal to the border expanding module 146 to expand the border portion of the window. The border portion of the window can be expanded, for example, from a first width to a second width greater than the first width. In some embodiments, the border portion of the window can be expanded, for example, from a width of 3 pixels to a width of 8 pixels. In some embodiments, the border portion of the window can be expanded, for example, from a width of 3 pixels to a width of 10 pixels. In some embodiments, the border portion of the window can be expanded, for example, from a width of 3 pixels to a width of 15 pixels. Thus, it should be understood that the border expanding module 146 can expand the border portion of a window from any first width to any desired second width. In some embodiments, the border expanding module 146 can expand a border portion while the application portion of the window appears to stay in the same or substantially the same position. For example, a center-point of the application portion of the window can remain at the same or substantially the same location on the display of the electronic device before and after the border portion of the window is expanded. The border expanding module 146 is described in more detail below with reference to FIGS. 4-8.

FIG. 4 illustrates an example window that can be defined and displayed on a display of an electronic device (e.g., electronic device 120). To place or define a window within a display of an electronic device (e.g., electronic device 120) and make it so that it is moveable/draggable, it is positioned absolutely using, for example, Cascading Style Sheets (CSS). This absolute positioning of a HTML element can be done by setting an XY coordinate of the window, which is the position of a top-left corner of the HTML element placed by the browser. As shown in FIG. 4, a window 148 (e.g., an HTML element) can be defined within a display 176 at an XY coordinate defined for a top left corner 178 of the window 148. The window 148 also has a center-point 174. The top left corner of the display 176 defines XY coordinates (0,0); the X-axis increases form left to right and the Y-axis increases form top to bottom.

The window 148 can include a border portion 152 and an application portion 154. The border portion 152 can have a width W₁, as shown in FIG. 5. In some embodiments, the width W₁ is, for example, 3 pixels. The window 148 can be defined by a grid of cells (e.g., an HTML table) including a center cell (corresponding to the application portion 154) surrounded by eight border cells (corresponding to the border portion 152).

Specifically, as shown in FIG. 6, which is a schematic illustration of the window 148, the border portion 152 can include a top border cell 156, a bottom border cell 158, a left border cell 162, and a right border cell 164, and four corner cells, including a top left border cell 166, a top right border cell 168, a bottom left border cell 170, and a bottom right border cell 172. The border portion 152 (i.e., the eight border cells) provides a frame or border area around the application portion 154. As described above, the border grabbing module 144 can associate an event listener component with each of the eight border cells to detect a mouseover event within the border portion 152.

Also as described above, the border expanding module 146 can expand or enlarge the width of the border portion 152 of the window 148 displayed on an electronic device (e.g., electronic device 120). The border cells (156, 158, 162, 164, 166, 168, 170, 172) can capture a user's mouseover action (e.g., via the event listener component discussed above), and triggering the border expansion module 146 to expand or enlarge the border portion 152.

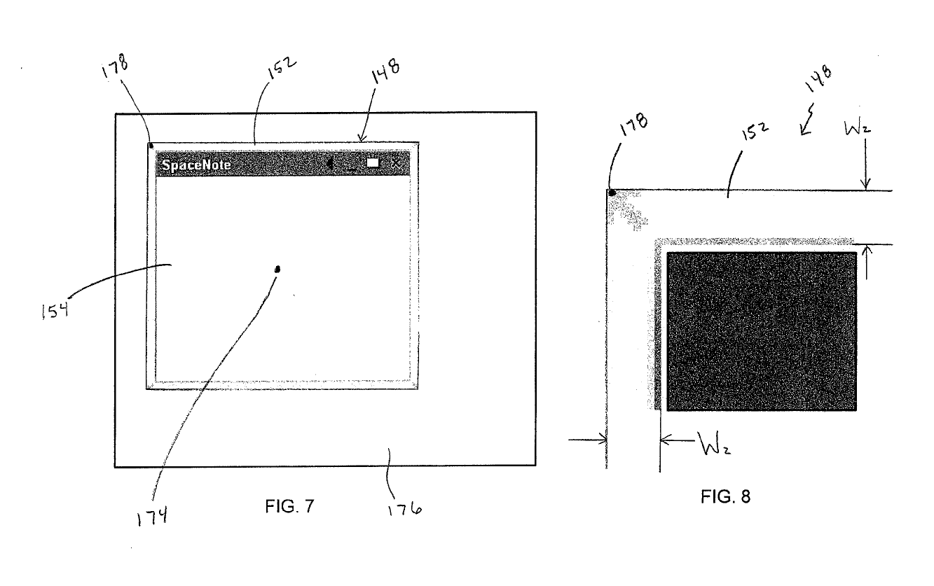

Specifically, as a user mouses over (e.g., moves a mouse cursor over) any of the eight border cells (156, 158, 162, 164, 166, 168, 170, 172), the border grabbing module 144 can detect the mouseover event and signal the border expanding module 146 that the border portion 152 should be expanded. The border expanding module 146 then increases the width of the border portion 152 as shown in FIGS. 7 and 8 (and described in more detail below). As shown in FIG. 8, the width W₁ (shown in FIG. 5) of the border portion 152 can be expanded to a width W₂. In some embodiments, the width W₁ of the border portion 152 is, for example, 3 pixels and the border portion 152 is expanded to a width W₂ of, for example, 8 pixels.

The border expanding process involves two simultaneous updates that can occur at a speed (e.g., faster than the eye can see) such that the application portion 154 of the window 148 appears to remain in the same, or substantially the same, location on the display 176 of the electronic device while the border portion 152 is expanded. For example, in some embodiments, the center-point 174 maintains a location (e.g., at a XY coordinate) within the display 176 before and after the expansion of the border portion 152.

Specifically, to expand or enlarge the width W₁ of the border portion 152, the border enhancing module 146 (1) causes a predetermined number of pixels to be added to all the window border cells (156, 158, 162, 164, 166, 168, 170, 172), and substantially simultaneously, (2) causes the whole window 148 to be moved to the left a predetermined number of pixels and up a predetermined number of pixels within the display 176. For example, to expand the border portion 152 from a width W₁ of 3 pixels to a width W₂ of 8 pixels, 5 pixels are added to the border portion 152 (i.e., border cells 156, 158, 162, 164, 166, 168, 170, 172), while substantially simultaneously, the window 148 is moved left 5 pixels and up 5 pixels. If the width of the border portion 152 were increased, for example, from 3 pixels to 8 pixels, without performing the border expansion process described above, the application portion 154 of the window 148 would move right 5 pixels and down 5 pixels within the display 176 because the XY coordinate (defined for the top left corner 178) of the window 148 remains unchanged. This movement, without performing the border expansion process described above, would result in an undesirable jumpiness of the window 148 on the display 176. The border expanding module 146 eliminates or reduces the movement of the window 148 on the display 176 by cancelling out the addition of 5 pixels to the border portion 152 (e.g., expanding the width from 3 pixels to 8 pixels) by simultaneously (or substantially simultaneously) moving the window 148 up 5 pixels and to the left 5 pixels.

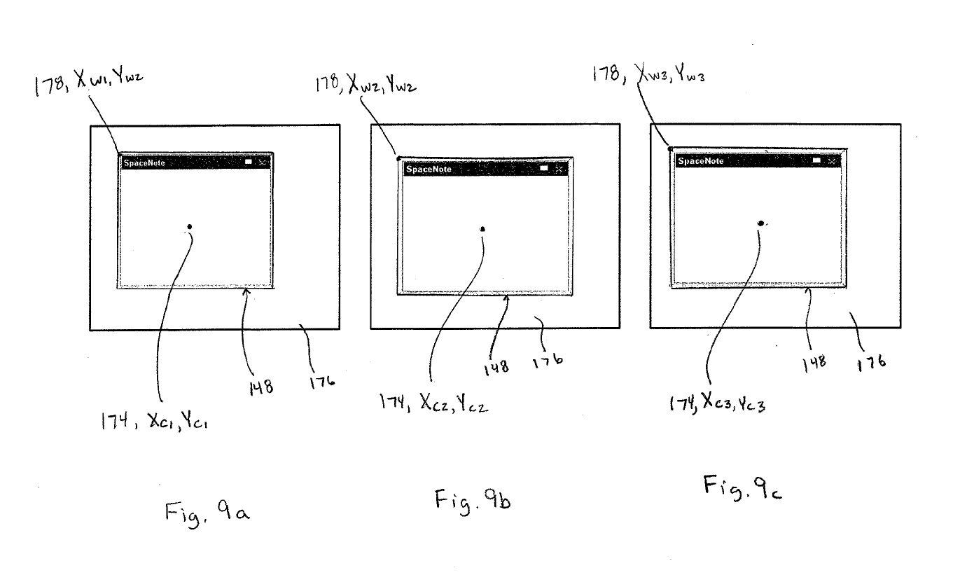

FIGS. 9a-9c illustrate the movement of the widow element 148 during an example expansion process in which the border portion 152 is expanded 5 pixels. As shown in FIG. 9a, at a first time prior to the border portion 152 being expanded, the top left corner 178 of the window 148 has XY coordinates X_{w1}, Y_{w1}, and the center-point 174 has XY coordinates X_{c1}, Y_{c1} within the display 176. Note that the top left corner 178 XY coordinates X_{w1}, Y_{w1} are maintained by the window 148, but the center-point 174 XY coordinates X_{c1}, Y_{c1} typically are not. At a second time, when the border expanding module 146 adds 5 pixels to the border portion 152, the top left corner 178 of the window 148 will have XY coordinates X_{w2}, Y_{w2}, and the center-point 174 will have XY coordinates X_{c2}, Y_{c2} as shown in FIG. 9b. The XY coordinates for the top left corner 178 of the window 148 and the center-point 174 at the second time will be as follows:

X_{w2}, Y_{w2}=X_{w1}, Y_{w1}

X_{c2}, Y_{c2}=(X_{c1}+5 pixels), (Y_{c1}+5 pixels)

As shown in FIG. 9b, at the second time when the border portion 152 is expanded (e.g., 5 pixels are added to the border portion 152), the center-point 174 of the window 148 is moved to the right 5 pixels and down 5 pixels. To compensate for this, the border expanding module 146 substantially simultaneously moves the window 148 to the left 5 pixels and up 5 pixels such that the top left corner 178 now has XY coordinates X_{w3}, Y_{w3} and the center-point 174 has XY coordinates X_{c3}, Y_{c3} as shown in FIG. 9c. The XY coordinates for the top left corner 178 of the window 148 and the center-point 174 after moving the window 148 will be as follows:

X_{w3}, Y_{w3}=(X_{w1}−5 pixels), (Y_{w1}−5 pixels)

X_{c3}, Y_{c3}=X_{c1}, Y_{c1}

Thus, the border expanding module 146 can cause the border portion 152 to expand, while the center-point 174 of the window 148 is maintained in the same (or substantially the same) position before and after the border expansion process.

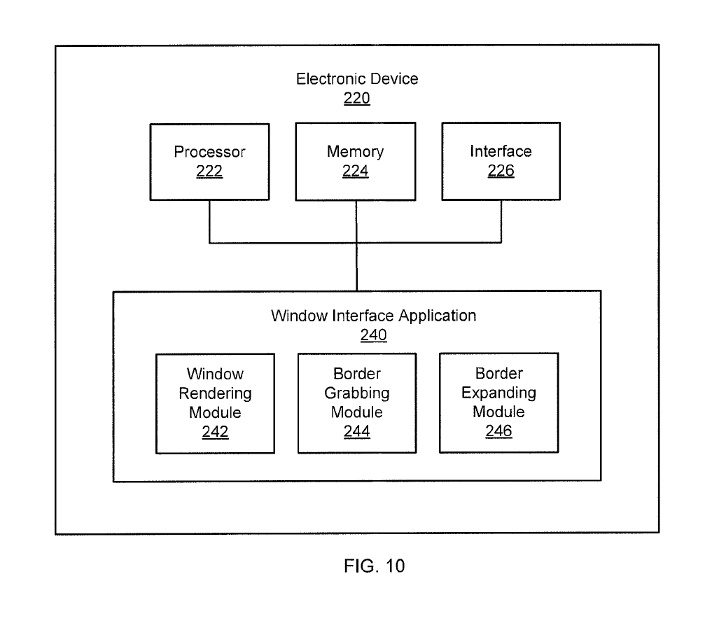

As discussed above, a window interface application (e.g., 140) can be provided to an electronic device (e.g., electronic device 120) via a server, such as window system server 130, or can be embodied directly on an electronic device. FIG. 10 is a schematic illustration of an embodiment of an electronic device 220 that includes a window interface application 240. The electronic device 220 can be configured the same and include any of the same features and functions as described above for electronic device 120.

The electronic device 220 can be any of a variety of electronic devices that can be operatively coupled, for example, to communications network (e.g., 160; not shown in FIG. 9). The electronic device 220 can be a personal computer, a laptop computer, a personal digital assistant (PDA), a cellular telephone, a portable/mobile internet device and/or some other electronic communication device. The electronic device 220 can include a web browser configured to access a webpage or website hosted on or accessible via a network server (not shown in FIG. 9) over a communications network (not shown in FIG. 9). The electronic device 220 can be configured to support, for example, HTML using JavaScript. For example, the electronic device 220 can include a web browser, such as, Firefox, Safari, Opera or Chrome. A webpage or website can be accessed by a user of a web browser at electronic device 220 by providing the web browser with a reference such as a uniform resource locator (URL), for example, of a webpage. In some embodiments, electronic device 220 can include specialized software for accessing a web server other than a browser, such as, for example, a specialized network-enabled application or program. In some embodiments, portions of a website accessible via a web server can be located in a database (not shown) accessible to the web server.

The electronic device 220 can include a processor 222, an interface 224, and a memory 226 each of which can be configured as described above for window system server 130 and electronic device 120. The electronic device 220 can also include (each not shown) a display or monitor, a keyboard, various ports (e.g., a USB port), and other user interface features, such as, for example, touch screen controls, audio components, and/or video components. The electronic device 220 can be operatively coupled to a communications network via the interface and a network connection as described above.

In this embodiment, the electronic device 220 also includes a window interface application 240 locally stored or implemented. In such an embodiment, the window interface application 240 need not be accessed or obtained off of the electronic device 220, for example, through a network or external communication link. The window interface application 240 can be configured the same and provide the same functions and features as described above for window interface application 140. The window interface application 240 can include a window rendering module 242, a border grabbing module 244 and a border expanding module 246. As described above, the window rendering module 242 can be any valid combination of hardware and/or software (executing on hardware) to provide a frame or border portion around an application portion of a window such that the window can be dragged, maximized and resized as described above for window rendering module 142 . The border grabbing module 244 can be any valid combination of hardware and/or software (executing on hardware) to detect when a mouseover event occurs over a portion of a border portion of the window as described above for border grabbing module 144. The border expanding module 246 can be any valid combination of hardware and/or software (executing on hardware) to expand the border portion of the window as described above for border expanding module 146.

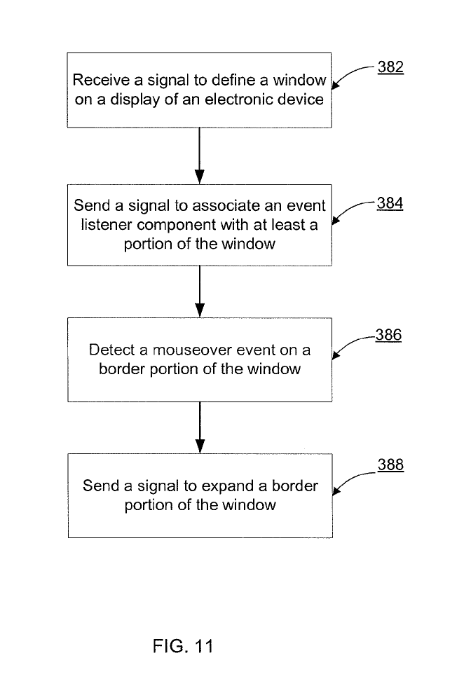

FIG. 11 is a flow chart illustrating a method of expanding a border portion of a window according to an embodiment. At 382, a signal can be received to define a window viewable on a display of an electronic device. For example, in some embodiments, a signal can be sent from a server (e.g., server 130) to an electronic device (e.g., 120, 220) that includes a window object (e.g., code) to define a window viewable on a display of the electronic device. In some embodiments, a signal can be sent from a processor of an electronic device (e.g., 120, 220) that includes a window object to define a window viewable on a display of the electronic device. The window can have an application portion and a border portion having a first width. The window can be defined with multiple cells as described above, for example, with reference to window 148.

At 384, a signal can be sent to associate an event listener component with at least a portion of the border portion of the window. For example, an event listener component can be defined for each of the border cells corresponding to the border portion of the window as described herein. At 386, a mouseover event on the border portion of the window can be detected via the event listener component. For example, the event listener component can detect when a user mouses a curser over the border portion of the window. At 388, a signal can be sent to expand the border portion of the window from the first width to a second width greater than the first width when a mouseover event is detected by the event listener component. In some embodiments, the border portion of the window can be expanded from a first width of 3 pixels to a second width of 8 pixels.

It is intended that the systems and methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments of the invention have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process when possible, as well as performed sequentially as described above. The embodiments have been particularly shown and described, but it will be understood that various changes in form and details may be made. For example, although various embodiments have been described as having particular features and/or combinations of components, other embodiments are possible having any combination or sub-combination of any features and/or components from any of the embodiments described herein.

What is claimed is:

1. A non-transitory processor-readable medium storing code representing instructions to cause a processor to:
define a window viewable on a display of a device, the window having an application portion and a border portion having a first width; and
expand the border portion of the window viewable on the display to a second width greater than the first width when a mouseover event is detected within the border portion of the window.

2. The non-transitory processor-readable medium of claim 1, further comprising code to:
associate an event listener component with at least a portion of the border portion to detect a mouseover event on the portion of the border portion, the border portion being expanded when a mouseover event is detected by the event listener component.

3. The non-transitory processor-readable medium of claim 1, wherein the code to expand the border portion is to expand the border portion from a first width of 3 pixels to a second width of 8 pixels.

4. The non-transitory processor-readable medium of claim 1, wherein the code to define the window is to define the window on the display at a first time such that a center point of the application portion of the window is at a location on the display, the code to expand the border portion is to expand the border portion at a second time while maintaining the center point of the application portion of the window at a location substantially corresponding to the location on the display at the first time.

5. The non-transitory processor-readable medium of claim 1, further comprising code to move the window left a predetermined number of pixels and up a predetermined number of pixels as the border portion is expanded from the first width to the second width substantially simultaneously.

6. The non-transitory processor-readable medium of claim 1, wherein the code to expand the border portion includes code to expand the border portion from a first width of 3 pixels to a second width of 8 pixels and substantially simultaneously move the window left 5 pixels and up 5 pixels.

7. A method, comprising:
receiving a signal to define a window viewable on a display of a device, the window having an application portion and a border portion having a first width;
associating an event listener component with at least a portion of the border portion to detect a mouseover event on the portion of the border portion; and
sending a signal to cause the border portion to expand to a second width greater than the first width when a mouseover event is detected by the event listener component.

8. The method of claim 7, wherein the expanding the border portion includes expanding the border portion from a first width of 3 pixels to a second width of 8 pixels.

9. The method of claim 7, wherein the defining the window includes defining the window on the display at a first time such that a center point of the application portion of the window is at a location on the display, the expanding the border portion includes expanding the border portion at a second time while maintaining the center point of the application portion of the window at a location substantially corresponding to the location on the display at the first time.

10. The method of claim 7, further comprising:
prior to sending the signal to define the window, sending a signal to the electronic device to define a user interface system at the electronic device.

11. The method of claim 7, further comprising:
prior to receiving the signal to define the window, sending a request for system code; and
receiving a signal at the electronic device to define a window interface application at the electronic device.

12. The method of claim 7, further comprising:
sending a signal to move the window left a predetermined number of pixels and up a predetermined number of pixels as the border portion is expanded from the first width to the second width substantially simultaneouslywindow.

13. The method of claim 7, wherein the signal to cause the border portion to expand includes code to expand the border portion from a first width of 3 pixels to a second width of 8 pixels and substantially simultaneously move the window left 5 pixels and up 5 pixels.

14. A non-transitory processor-readable medium storing code representing instructions to cause a processor to:
send a signal to an electronic device to define a window viewable on a display of the electronic device, the window having an application portion and a border portion having a first width, the signal to cause at the electronic device,
an event listener component to be associated with at least a portion of the border portion of the window, the event listener component to detect a mouseover event on the portion of the border portion of the window, and
the border portion of the window to be expanded to a second width greater than the first width when a mouseover event is detected by the event listener component.

15. The non-transitory processor-readable medium of claim 14, wherein the border portion is expanded from a first width of 3 pixels to a second width of 8 pixels when a mouseover event is detected by the event listener component.

16. The non-transitory processor-readable medium of claim 14, wherein window is defined on the display at a first time such that a center point of the application portion of the window is at a location on the display, the border portion is expanded at a second time while maintaining the center point of the application portion of the window at a location substantially corresponding to the location on the display at the first time.

17. The non-transitory processor-readable medium of claim 14, further comprising code to:
prior to sending the signal to define the window, send a signal to the electronic device to define a window interface application at the electronic device.

18. The non-transitory processor-readable medium of claim 14, further comprising code to:
prior to sending the signal to define the window, receive a request for system code;
and send a signal to the electronic device to define a window interface application at the electronic device in response to the requests for system code.

19. The non-transitory processor-readable medium of claim 14, wherein the border portion is expanded from the first width to the second width and substantially simultaneously the window is moved left a predetermined number of pixels and up a predetermined number of pixels when a mouseover event is detected by the event listener component.

20. The non-transitory processor-readable medium of claim 14, wherein the border portion is expanded from a first width of 3 pixels to a second width of 8 pixels and substantially simultaneously the window is moved up 5 pixels and left 5 pixels when a mouseover event is detected by the event listener component.
